(19) United States
(12) Patent Application Publication
(10) Pub. No.: US 2026/0213035 A1
(43) Pub. Date: Jul. 23, 2026

(54) LASER BEAM THREAD TRAP FOR INDIVIDUAL CIRCULAR RYDBERG ATOMS

(71) Applicant: Yale University, New Haven, CT (US)

(72) Inventor: Rodrigo G. Cortiñas, New Haven, CT (US)

(73) Assignee: Yale University, New Haven, CT (US)

(21) Appl. No.: 18/607,171

(22) Filed: Mar. 15, 2024

Related U.S. Application Data
(60) Provisional application No. 63/490,277, filed on Mar. 15, 2023.

(51) Int. Cl. G21K 1/30; G06N 10/40

(52) U.S. Cl. CPC G21K 1/30; G06N 10/40

(57) ABSTRACT

Systems and methods for performing quantum information processing using a quantum device including a quantum oscillator dispersively coupled to a physical qubit comprising a trapped Rydberg atom are provided. The techniques include laser-trapping an atom using a laser beam focused to a Gaussian waist with a width less than a diameter of an orbital of an outermost electron of the trapped circular Rydberg atom.

### RELATED APPLICATIONS

This application claims the benefit under 35 U.S.C. § 119(e) of U.S. Provisional Application Ser. No. 63/490,277, filed Mar. 15, 2023, entitled “LASER BEAM THREAD TRAP FOR INDIVIDUAL CIRCULAR RYDBERG ATOMS”, which is hereby incorporated herein by reference in its entirety.

### BACKGROUND

A Rydberg atom is an excited atom with one or more electrons that have a large principal quantum number, n. The higher the value of n, the farther the electron is from the nucleus, on average. The core electrons shield the outer electron(s) from the electric field of the nucleus such that, from a distance, the electric potential looks identical to that experienced by the electron in a hydrogen atom. Rydberg atoms exhibit a number of interesting properties including large coupling to electromagnetic fields, large mutual dipole-dipole interactions, and long lifetimes.

### SUMMARY

In some aspects, the techniques described herein relate to a quantum device, including: a quantum oscillator; and a physical qubit dispersively coupled to the quantum oscillator, the physical qubit including a trapped Rydberg atom.

In some aspects, the techniques described herein relate to a quantum device, wherein the quantum oscillator includes a bosonic system.

In some aspects, the techniques described herein relate to a quantum device, wherein the quantum oscillator includes a microwave resonator cavity.

In some aspects, the techniques described herein relate to a quantum device, further including a laser trap configured to trap the trapped Rydberg atom.

In some aspects, the techniques described herein relate to a quantum device, wherein the laser trap includes: one or more electrodes positioned adjacent a first laser beam present during operation of the laser trap; and a lens configured to, during operation of the laser trap, focus the first laser beam to a Gaussian waist with a width less than a diameter of the trapped circular Rydberg atom.

In some aspects, the techniques described herein relate to a quantum device, wherein the first laser beam has a wavelength, λ₁, and the lens is configured to, during operation of the laser trap, focus the first laser beam to a Gaussian waist with a width approximately equal to λ₁/2.

In some aspects, the techniques described herein relate to a quantum device, wherein the lens has a numerical aperture in a range from 0.3 to 0.9.

In some aspects, the techniques described herein relate to a quantum device, wherein the trapped circular Rydberg atom includes an alkali metal atom.

In some aspects, the techniques described herein relate to a quantum information processing system, including: the quantum device; and one or more energy sources coupled to the quantum oscillator and the physical qubit.

In some aspects, the techniques described herein relate to a quantum information processing system, further including a laser trap configured to trap the trapped Rydberg atom.

In some aspects, the techniques described herein relate to a quantum information processing system, wherein the laser trap includes: one or more electrodes positioned adjacent a first laser beam present during operation of the laser trap; and a lens configured to, during operation of the laser trap, focus the first laser beam to a Gaussian waist with a width less than a diameter of the trapped Rydberg atom.

In some aspects, the techniques described herein relate to a quantum information processing system, wherein the first laser beam has a wavelength, λ₁, and the lens is configured to, during operation of the laser trap, focus the first laser beam to a Gaussian waist with a width approximately equal to λ₁/2.

In some aspects, the techniques described herein relate to a quantum information processing system, wherein the lens has a numerical aperture in a range from 0.3 to 0.9.

In some aspects, the techniques described herein relate to a quantum information processing system, wherein the quantum oscillator includes a bosonic system.

In some aspects, the techniques described herein relate to a quantum information processing system, wherein the quantum oscillator includes a microwave resonator cavity.

In some aspects, the techniques described herein relate to a method of performing quantum information processing including: dispersively coupling a physical qubit to a quantum oscillator by: trapping a Rydberg atom at a position internal to the quantum oscillator; and creating a large Kerr nonlinearity in the physical qubit by transferring a state of the trapped Rydberg atom into a circular state to create a trapped circular Rydberg atom; encoding a qubit state in the quantum oscillator; and measuring a state of the physical qubit.

In some aspects, the techniques described herein relate to a method, wherein encoding a qubit state in the quantum oscillator includes applying one or more microwave fields to the quantum oscillator.

In some aspects, the techniques described herein relate to a method, wherein measuring a state of the physical qubit includes measuring the state of the physical qubit using ionization spectroscopy.

In some aspects, the techniques described herein relate to a method, wherein trapping the Rydberg atom includes: focusing, at a focal point, a first laser beam having a wavelength, to a Gaussian waist with a width of approximately; positioning a Rydberg atom at the focal point; and exciting the Rydberg atom from a ground state to an excited state using a two-photon excitation process caused by the first laser beam and a second laser beam having a wavelength.

In some aspects, the techniques described herein relate to a method, wherein transferring the state of the trapped Rydberg atom into a circular state includes applying circularly polarized microwave signals to the trapped Rydberg atom.

### BRIEF DESCRIPTION OF DRAWINGS

Various aspects and embodiments will be described with reference to the following figures. It should be appreciated that the figures are not drawn to scale. In the drawings, each identical or nearly identical component that is illustrated in various figures is represented by a like numeral. For purposes of clarity, not every component may be labeled in every drawing.

FIG. 1A is a schematic diagram of a quantum system 100, in accordance with some embodiments of the technology described herein.

FIG. 1B is a schematic diagram of a quantum device of the quantum system 100, in accordance with some embodiments of the technology described herein.

FIG. 2A is a schematic diagram of a laser trapping device, in accordance with some embodiments of the technology described herein.

FIG. 2B is a schematic diagram of energy levels of a Rydberg atom, in accordance with some embodiments of the technology described herein.

FIG. 3A is an illustration of a circular Rydberg atom trapped in a laser trap, in accordance with some embodiments of the technology described herein.

FIG. 3B is a plot showing radial trapping potentials for a laser beam thread trap for various circular Rydberg states, in accordance with some embodiments of the technology described herein.

FIG. 3C is a plot showing axial trapping potentials for a laser beam thread trap for various circular Rydberg states, in accordance with some embodiments of the technology described herein.

FIG. 4A is a plot of radial laser trapping potential as a function of laser wavelength for various circular Rydberg states, in accordance with some embodiments of the technology described herein.

FIG. 4B is a plot of the axial laser trapping potential as a function of laser wavelength for various circular Rydberg states, in accordance with some embodiments of the technology described herein.

FIG. 4C is a plot of the radial trap frequency as a function of laser wavelength for various circular Rydberg states, in accordance with some embodiments of the technology described herein.

FIG. 4D is a plot of the axial trap frequency as a function of laser wavelength for various circular Rydberg states of, in accordance with some embodiments of the technology described herein.

FIG. 4E is a plot of the radial Kerr frequency as a function of laser wavelength for various circular Rydberg states, in accordance with some embodiments of the technology described herein.

FIG. 4F is a plot of the axial Kerr frequency as a function of laser wavelength for various circular Rydberg states, in accordance with some embodiments of the technology described herein.

FIG. 5 is a plot of the measured coherence signal of a trapped circular Rydberg atom, in accordance with some embodiments of the technology described herein.

FIG. 6 is a flowchart describing a process 600 of performing quantum information processing, in accordance with some embodiments of the technology described herein.

### DETAILED DESCRIPTION

Described herein are techniques for trapping and circularizing Rydberg atoms using a laser trap and techniques for using a trapped circular Rydberg atom for quantum information processing. The techniques include generating a focused laser beam with a Gaussian waist having a width less than a diameter of the circular Rydberg atom (e.g., less than a diameter of the orbital of the excited electron of the Rydberg atom). The techniques also include dispersively coupling the trapped circular Rydberg atom to a bosonic system (e.g., a quantum oscillator), such that the trapped circular Rydberg atom may act as an ancilla qubit coupled to the bosonic system. The trapped circular Rydberg atom may then be used to control and/or probe the states of the bosonic system to perform quantum information processing.

As described above, Rydberg atoms are atoms, typically of an alkali metal, with one or more electrons having a very high principal quantum number (n>>1) such that these electrons are located very far from the nucleus of the atom, causing the atom to have a very large size. Circular Rydberg atoms are Rydberg atoms having maximal angular momentum quantum numbers of m=l=n−1 and are of particular interest because they exhibit even longer lifetimes, on the order of tens of milliseconds at cryogenic temperatures.

Laser trapping individual circular Rydberg atoms enables their use in applications calling for individual neutral atoms. For example, laser-trapped Rydberg atoms may have many applications in quantum computing technologies. Laser-trapped Rydberg atoms may be used as individual qubits to perform quantum computation and simulation. As another example, circular Rydberg atoms may be used as stable ancilla qubit coupled to a bosonic system (e.g., quantum oscillators, including but not limited to microwave resonator cavities), the circular Rydberg atom being used to control bosonic quantum error correction codes in cavity quantum electrodynamics (cQED).

The inventors have recognized and appreciated that the use of circular Rydberg atoms as ancilla qubits presents several advantages compared to charge qubits. First, the lifetime of circular Rydberg atoms, which is on the order of tens of milliseconds, is significantly longer than the coherence time of charge qubits, which is on the order of tens to approximately 100 microseconds. The longer lifetime of circular Rydberg atoms allows for the performance of longer quantum circuits, thereby increasing the complexity of quantum algorithms that may be performed using the quantum system. Additionally, the long coherence times of circular Rydberg atoms reduces the formations of both T₁ and T₂ errors in the ancilla qubit, thereby reducing errors transmitted to the data stored in the bosonic system, increasing fidelity of the quantum system. As additional examples, the coupling between a circular Rydberg atom and a bosonic system is stronger than the coupling between a charge qubit and a bosonic system, and the nonlinearity of a circular Rydberg atom (e.g., the Kerr nonlinearity) may be tuned to be much larger than that of a charge qubit.

The inventors have further recognized and appreciated that laser-trapping a circular Rydberg atom and coupling the trapped circular Rydberg atom to a bosonic system increases the interaction time between the coupled devices to the lifetime of the trapped circular Rydberg atom. Conventionally, circular Rydberg atom ancilla qubits have been coupled to bosonic systems by transmitting the circular Rydberg atom through the bosonic system. In such systems, the interaction time between the circular Rydberg atom and the bosonic system has been limited to the time it takes the circular Rydberg atom to pass through the bosonic system. By trapping the circular Rydberg atom and coupling the trapped circular Rydberg atom to the bosonic system, the interaction time between the coupled devices is increased effectively to the lifetime of the trapped circular Rydberg atom.

However, laser trapping circular Rydberg atoms presents additional challenges compared to laser trapping of noncircular Rydberg atoms. Circular Rydberg atoms have no optically allowed transitions and instead must conventionally be trapped by the use of darkness within an optical trap (e.g., the intensity distribution of the optical trap includes “holes” which trap the circular Rydberg atoms). However, such traps are relatively power inefficient and difficult to implement.

The inventors have recognized and appreciated that, rather than using complex light patterns to trap circular Rydberg atoms, simpler optical patterns may be used to trap circular Rydberg atoms by using ponderomotive trapping (e.g., a trapping force which causes the atom to move towards an area of weaker field strength). The inventors have therefore developed a laser trapping mechanism which uses a tightly focused Gaussian beam to trap the circular Rydberg atom by trapping the outermost electron. An additional benefit of this laser trap is that the same laser can be used to trap the ground state atom and the excited Rydberg atom, thereby reducing the number of lasers needed to trap the circular Rydberg atom and simplifying manufacture and operation of the laser trap.

In some embodiments, the laser trap uses a laser configured to generate a laser beam having a wavelength, λ₁, (e.g., λ₁≈420 nm, although other wavelengths may be used). At a focal point of the trap, the laser beam is focused (e.g., using a lens having a high numerical aperture in a range from 0.3 to 0.9) to a Gaussian waist. The Gaussian waist has a width, w, less than a diameter of the excited electron orbital of the trapped Rydberg atom. In some embodiments, the Gaussian waist may have a width, w, approximately equal to λ₁/2. The Gaussian waist provides a trapping potential along axial and longitudinal directions relative to the laser beam (e.g., perpendicular to the laser beam along its radius and parallel to the laser beam along its length). The circular Rydberg electron of the atom is then trapped at the Gaussian waist, thereby pinning the entire atom bound to the electron within the trap.

Following below are more detailed descriptions of various concepts related to, and embodiments of, methods and apparatus for trapping circular Rydberg atoms and use of trapped circular Rydberg atoms to perform quantum information processing. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

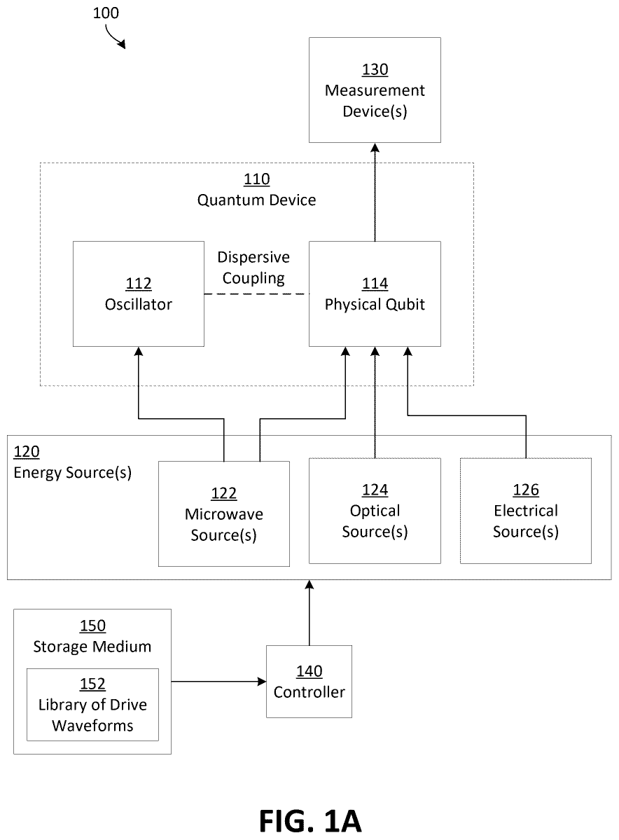

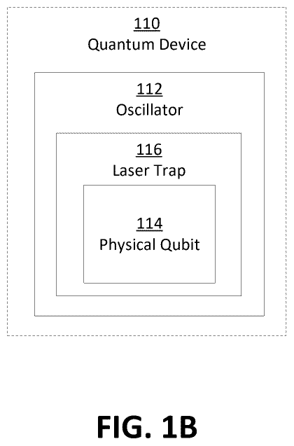

FIG. 1A is a schematic diagram of a quantum system 100, in accordance with some embodiments of the technology described herein. Quantum system 100 includes a quantum device 110 having an oscillator 112 coupled to a physical qubit 114. The oscillator 112 may be, for example, a bosonic system including but not limited to a quantum harmonic oscillator or a microwave cavity resonator. The physical qubit 114 may be a trapped circular Rydberg atom. The trapped circular Rydberg atom may be, for example, any Rydberg atom that may be circularized, including but not limited to alkali metal atoms. Techniques and examples described herein are described with reference to ⁸⁷Rb atoms in particular, but it should be appreciated that ⁸⁷Rb is only one example of a Rydberg atom that may be circularized and implemented as physical qubit 114, as aspects of the technology described herein are not limited in this respect.

The atomic orbital of a circular Rydberg state with principal quantum number n is a toroid centered at radius r_{nc}=a₀n², where a₀ is the Bohr radius, with a radial fuzziness Δr_{nc} such that Δr_{nc}/r_{nc}<<1 for n>>1. From this property follows that circular atoms have a long free-space lifetime τ_{nc}∝n⁵, here, for rubidium, τ_{50c}≈28 ms, in nondemanding cryogenic conditions (≲1 K). This timescale can be understood quantitatively in semiclassical terms: a charged electron orbiting at such distances from the nucleus will emit Larmor radiation at a photon rate≈1/τ_{nc}. The photon can be shown to have an energy ℏω_{nc}∂n⁻³, which reflects the dipole transition frequency of the single dominant decay channel of these states in free space, |_{nc} [symbol] →|(n−1)c [symbol] (where ω_{50c}/2π≈54 GHz and ω_{100c}/2π≈6 GHz, for example). It is estimated, by assuming that (i) all electron-photon scattering events are causing unwanted transitions and (ii) using the Thomson cross section

$${σ}_{c} = 8 π {r}_{e}^{2} / 3$$

where rₑ is the radius of the outer electron orbital, that the coherence lifetime in the thread trap is limited by photon scattering to tens of seconds.

In some embodiments, the oscillator 112 is coupled to the physical qubit 114 by dispersive coupling. Dispersive coupling occurs when the resonant frequencies of the oscillator 112 and the physical qubit 114 are detuned by a detuning, Δ=ωₒ−ω_{q}, where ωₒ and ω_{q} are the resonant frequencies of the oscillator 112 and the physical qubit 114, respectively, the detuning Δ being much larger (e.g., an order of magnitude or more) than the coupling strength between the oscillator 112 and the physical qubit 114. For the case of a microwave cavity, ωₒ~MHz, while for a Rydberg atom, ω_{q}~GHz or THz. The dispersive coupling between the oscillator 112 and the physical qubit 114 means that there is a shift in the resonant frequency of the physical qubit 114 that is dependent on the state of the oscillator 112, such that the state of the oscillator 112 may be probed non-destructively by probing the physical qubit 114.

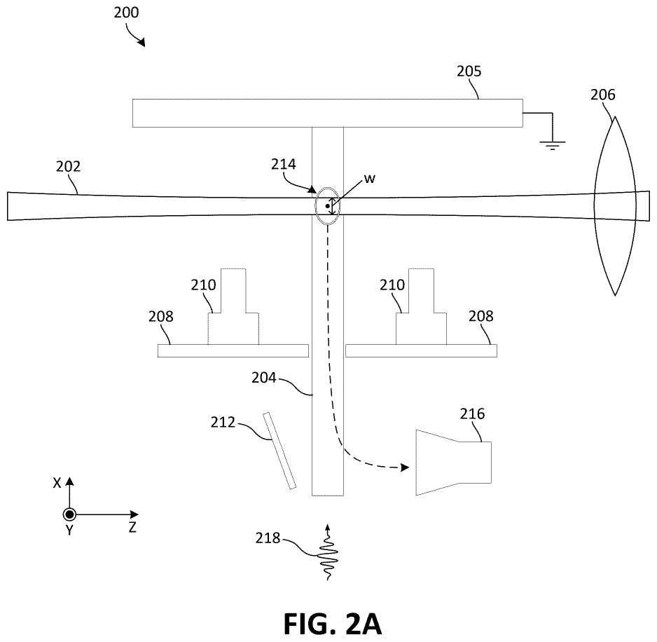

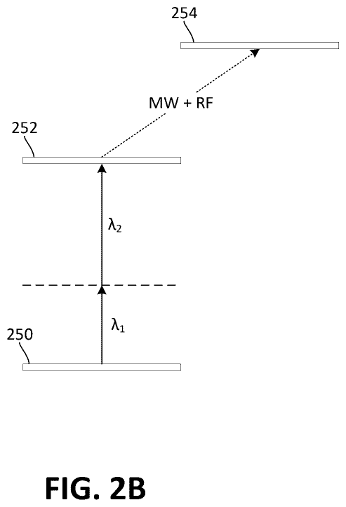

In some embodiments, the physical qubit 114 may be disposed at a position internal to the oscillator 112, as illustrated in the schematic diagram of FIG. 1B. For example, the physical qubit 114 may be positioned within the oscillator 112 by laser trap 116. The laser trap 116 may be configured to trap and generate a circular Rydberg atom to create the dispersive coupling between the physical qubit 114 and the oscillator 112. An example of a laser trap 116 is described herein with reference to FIG. 2A, which is a schematic diagram of a laser trapping device 200, in accordance with some embodiments of the technology described herein. The laser trapping device 200 may be used as laser trap 116 in the quantum system 100, in some embodiments.

In some embodiments, laser trapping device 200 (and quantum device 110) may be housed in a liquid helium-based cryostat and operated at cryogenic temperatures (e.g., ≤4 K). The laser trapping device 200 may be implemented as a three-dimensional mirror magneto-optical trap (MOT) created in front of a metallic mirror 205. Atoms 214 may be loaded into the three-dimensional MOT by streaming an atomic beam out of a two-dimensional MOT and along the y-axis.

The atoms 214 may be positioned at an intersection of a first laser beam 202 and a second laser beam 204. The first laser beam 202 may have a first wavelength, λ₁, and the second laser beam 204 may have a second wavelength, λ₂. In some embodiments, the first wavelength, λ₁, may be approximately 420 nm. The first and second wavelengths may be configured to cause two-photon excitation of the trapped atom 214. As shown in FIG. 2B, which is a schematic diagram of energy levels of a Rydberg atom, the two-photon excitation may cause the trapped atom 214 to be excited from a ground state 250 to an excited state 252.

In some embodiments, the laser trapping device 200 includes a lens 206. The lens 206 may be configured to, during operation of the laser trapping device 200, focus the first laser beam 202 to a Gaussian waist with a width, w. The width, w, may be less than a diameter of an orbital of the outermost electron of the Rydberg atom 214 such that the first laser beam 202 “threads” through the orbital and traps the nucleus of the Rydberg atom 214 at a center of the first laser beam 202. In some embodiments, the lens 206 may be configured to focus the first laser beam 202 to a width approximately equal to λ₁/2.

In some embodiments, to focus the first laser beam 202 to a Gaussian waist with a suitable width, the lens 206 may be a lens having a relatively large numerical aperture (NA). For example, the lens 206 may have an NA in a range from 0.3 to 0.9, an NA of 0.65, an NA of 0.7, or an NA of 0.9, in some embodiments. The wavelength, λ₁, may then be selected based on the desired circular state of the trapped atom 214 and the NA of the lens 206. Table 1 provides non-limiting examples of suitable wavelengths, λ₁, for a laser trapping device 200 having a lens 206 with an NA=0.65 and a trapped atom 214 comprising ⁸⁷Rb.

In some embodiments, the laser trapping device 200 includes a pierced electrode 208. The pierced electrode 208 may be configured to, in combination with the grounded metallic mirror 205, apply an electric field along the x-axis. For example, an electrical source 126 may be configured to apply a voltage to the pierced electrode 208 in order to generate the electric field. The electric field may be configured to lift degeneracy of the excited state 252 of the trapped Rydberg atom 214.

TABLE 1
Trapping conditions for beams focused to w ≈ λ₁/2 and different circular
states, as derived from λ < 2\sqrt{2}a₀n².

| \|nc [symbol] | λ₁ | |
|---|---|---|
| \|50c [symbol] | <374 | nm |
| \|60c [symbol] | <538 | nm |
| \|70c [symbol] | <733 | nm |
| \|80c [symbol] | <957 | nm |
| \|90c [symbol] | <1212 | nm |

In some embodiments, the laser trapping device 200 includes compensation electrodes 210. While the cross-sectional view of FIG. 2A shows only two compensation electrodes 210, in some embodiments the laser trapping device 200 may include four compensation electrodes 210. The compensation electrodes 210 may be configured to generate compensation electric fields to minimize field gradients in the electric field generated by the pierced electrode 208.

Additionally, in some embodiments, the compensation electrodes 210 may be used to circularize the state of the trapped Rydberg atom 214. The excited state 252 of the trapped Rydberg atom 214 may be adiabatically transferred to the circular state 254 by applying a microwave pulse 218 (e.g., generated by one of microwave sources 122) to the trapped Rydberg atom 214. The compensation electrodes 210 may be configured to circularly polarize the microwave pulse 218 in order to transfer the excited state 252 to the circular state 254. In some embodiments, additional radio frequency (RF) fields may be applied to the trapped Rydberg atom 214 to adiabatically transfer the excited state 252 to the circular state 254. For example, the compensation electrodes 210 may be used to generate additional RF fields by applying electric potentials with an RF frequency on two adjacent electrodes of the compensation electrodes 210.

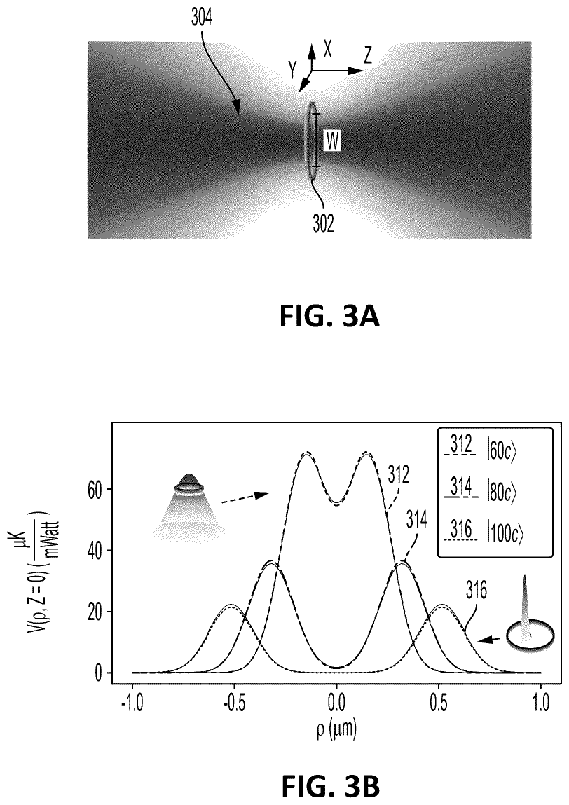

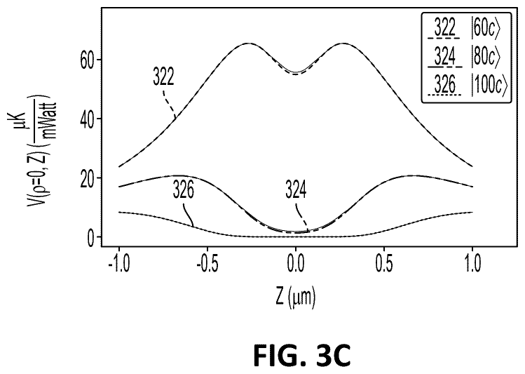

FIG. 3A shows an illustrative example of a circular Rydberg atom trapped by a threaded laser trap, in accordance with some embodiments of the technology described herein. The trapped circular Rydberg atom has an electron orbital 302 having a diameter greater than the Gaussian waist, w, of the first laser beam 304 such that the Gaussian waist “threads” the circular Rydberg atom.

Returning to FIG. 2A, in some embodiments, it may be desirable to measure the population of individual Rydberg levels. Accordingly, in some embodiments, the compensation electrodes 210 may apply an electric field ramp configured to successively ionize the Rydberg levels of the trapped Rydberg atom 214. The trapped ion may then be guided to a channeltron 216 by deflection electrode 212.

Returning to FIG. 1A, in some embodiments, the quantum system 100 includes one or more energy sources 120. The energy sources 120 may be configured to provide energy to the oscillator 112 and/or the physical qubit 114 in order to perform operations on the system such as circularizing the trapped Rydberg atom, encoding a state of the physical qubit 114 in the oscillator 112, applying unitary operations to the oscillator 112 and/or to the physical qubit 114, or combinations thereof.

In some embodiments, the energy sources 120 may include one or more of microwave sources 122, optical sources 124, and/or electrical sources 126. The microwave sources 122 may be configured to, for example, generate microwave signals to be applied to the oscillator 112 and/or the physical qubit 114. The microwave signals may be configured to cause, for example, circularization of the trapped Rydberg atom of the physical qubit 114 (e.g., as described in connection with microwave signals 218), to initialize a state of the oscillator 112, and/or to implement one or more quantum operations on the quantum device 110.

In some embodiments, the optical sources 124 may be configured to provide one or more laser beams to the laser trap 116 (e.g., laser beams 202 and/or 204). The laser beams may be configured to cause two-photon excitation of the trapped atom to generate a trapped Rydberg atom, as described in connection with FIG. 2B herein.

In some embodiments, the electrical sources 126 may be configured to provide one or more electrical signals to the laser trap 116. For example, the electrical sources 126 may be configured to provide one or more voltage signals to the electrode 208 and/or the electrode 212. Alternatively or additionally, the electrical sources 126 may be configured to provide one or more voltage signals to the compensation electrodes 210, the provided voltage signals generating compensatory electrical fields and/or electrical fields configured to circularly polarize microwave signals 218.

In some embodiments, the quantum system 100 further includes one or more measurement devices 130 configured to measure aspects of the physical qubit 114. For example, the one or more measurement devices 130 may include a channeltron (e.g., channeltron 216) configured to perform ionization spectroscopy by measuring an ionization state of the physical qubit 114. Alternatively or additionally, the one or more measurement devices 130 may include optical and/or electronic sensors configured to probe the state of the physical qubit 114.

In some embodiments, the quantum system 100 includes a controller 140 configured to control the energy sources 120 and a storage medium 150. The storage medium 150 may store a library of pre-computed drive waveforms 152. The controller 140 may be configured to access the library of drive waveforms 152 stored on the storage medium 150 in order to apply said drive waveforms to the quantum device 110. For example, the controller 140 may be configured to provide one or more drive waveforms obtained from the pre-computed drive waveforms 152 to one or more of the energy sources 120 to cause the one or more of the energy sources 120 to apply electromagnetic signals to the oscillator 112 and/or the physical qubit 114.

FIGS. 3B and 3C are plots showing calculated radial (ρ) and axial (Z) trapping potentials, respectively, for a laser beam thread trap for various circular Rydberg states, in accordance with some embodiments of the technology described herein. FIG. 3B includes schematics of the Gaussian beam within the atomic orbital in two limiting cases. The trapping potentials are calculated for a wavelength λ₁=420 nm focused to a Gaussian waist of w=λ₁/2 and circular states n=60 (curves 312 and 322), n=80 (curves 314 and 324), and n=100 (curves 316 and 324). The focal point of the beam is at the origin of both FIGS. 3B and 3C. Curves 312-316 and 322-326 correspond to the integration of the laser intensity over the three-dimensional toroidal wave function, ψ_{nc}. The solid lines correspond to a curvilinear integration of the laser intensity along the semiclassical Bohr orbit.

Due to the subatomic-scale laser beam that is used, the trap is tridimensional as the circular atom cannot run along the axis of the strongly divergent beam. The atom is thus localized within a fraction of the Rayleigh length along the axial direction. It is important to note that since this trap does not rely on a dipole resonance, the wavelength λ₁ is comparatively unconstrained. Although the trapping potential depth scales as λ₁² for a given laser power, the main consideration for implementation is the diffraction-limited waist at ≈λ₁. Note that the freedom in laser wavelength, beam waist, and the principal quantum number n provides flexibility and different configurations of interest. This tunability is illustrated in FIGS. 3B and 3C by plotting the trapping potential for n=60, 80 and 100. For n=60, the strongest linear confinement is observed, which vanishes as n grows for a fixed beam waist.

The circular wave function is found by solving the Schrödinger equation for the hydrogen atom, which is an excellent approximation for circular Rydberg states of alkali metals, and reads, in spherical coordinates:

$${ψ}_{nc} ( r , θ , ϕ ) = \frac{{e}^{- r / {na}_{0}}}{{( π {a}_{0}^{3} )}^{1 / 2}} \frac{1}{nn !} {( - \frac{r}{{a}_{0} n} sin θ {e}^{i ϕ} )}^{n - 1} .$$

The integral V∝∫I|ψ_{nc}|²d\vec{r}, over the tightly focused Gaussian beam of intensity I, is used to numerically compute the curves 312-316 and 322-326 of FIGS. 3B and 3C. In the following, however, the circular orbital is approximated by a circular one-dimensional Bohr orbit to get analytical expressions for the properties of the trap. The confining potential computed under this semiclassical approximation is shown as solid lines in FIGS. 3B and 3C. The ponderomotive potential for an atom whose nucleus is located at (X, Y, Z) then reads

$$\begin{matrix}V ( X , Y , Z ) \approx \frac{1}{2 π} {\int }_{0}^{2 π} d θ \frac{{q}_{e}^{2}}{{m}_{e} {ε}_{0} c} \frac{{λ}_{1}^{2}}{{( 2 π c )}^{2}} \frac{{𝒫}_{0}}{π {w}^{2} ( Z )} \\ \times {e}^{- \frac{2}{{w}^{2} ( Z )} [ {( {X}_{n} + X )}^{2} + {( {Y}_{n} + Y )}^{2} ]}\end{matrix}$$

where qₑ and mₑ are the charge and mass of the electron, ∈₀ is the permittivity of free space and c is the speed of light in vacuum, λ₁ is the wavelength of the threading laser, [symbol] ₀ is the laser power, Xₙ=r_{nc} cos θ and Yₙ=r_{nc} sin θ are the circular Rydberg electron coordinates with respect to the atomic nucleus, Z is the position of the nucleus and of the electron along the laser propagation axis, and w(Z)=w₀\sqrt{1+(Z/Z_{R})²} is the Gaussian waist of the laser beam, where

$${Z}_{R} = π {w}_{0}^{2} / {λ}_{1}$$

is the Rayleigh length of the beam. Here the origin of the coordinates has been placed at the focal point of the beam.

The mechanical trapping frequency along the axial direction for a circular Rydberg state |nc [symbol] at ρ=\sqrt{X²+Y²}=0 is found by differentiation to be:

$${ω}_{z}^{2} = \frac{{q}_{e}^{2}}{{m}_{e} {ϵ}_{0} c} \frac{{λ}_{1}^{2}}{{( 2 π c )}^{2}} \frac{2 {𝒫}_{0}}{π {w}_{0}^{4}} \frac{( 2 {r}_{nc}^{2} - {w}_{0}^{2} ) {e}^{- 2 {r}_{nc}^{2} / {w}_{0}^{2}}}{{Z}_{R}^{2} {m}_{Rb}}$$

where m_{Rb} is the mass of ⁸⁷Rb, although it should be appreciated that this theoretical framework applies to any Rydberg atom. The axial nonlinearity from Taylor expanding the trapping potential around Z=0 as V(ρ=0, Z)≈k_{0,z}+k_{2,z}Z²+k_{4,z}Z⁴ is:

$${k}_{4 , z} = \frac{{q}_{e}^{2}}{{m}_{e} {ϵ}_{0} c} \frac{{λ}_{1}^{2}}{{( 2 πc )}^{2}} \frac{{𝒫}_{0}}{π {w}_{0}^{6}} \frac{( 2 {r}_{nc}^{4} - 4 {r}_{nc}^{2} {w}_{0}^{2} + {w}_{0}^{4} ) {e}^{- 2 {r}_{nc}^{2} / {w}_{0}^{2}}}{{Z}_{R}^{4}} ,$$

while the associated Kerr nonlinearity, defined as

$${K}_{z} = 3 ℏ \frac{( 2 {r}_{nc}^{4} - 4 {r}_{nc}^{2} {w}_{0}^{2} + {w}_{0}^{4} )}{{m}_{Rb} ( 2 {r}_{nc}^{2} - {w}_{0}^{2} ) {w}_{0}^{2} {Z}_{R}^{2}} .$$

is:

$${K}_{z} = 3 ℏ \frac{( 2 {r}_{nc}^{4} - 4 {r}_{nc}^{2} {w}_{0}^{2} + {w}_{0}^{4} )}{{m}_{Rb} ( 2 {r}_{nc}^{2} - {w}_{0}^{2} ) {w}_{0}^{2} {Z}_{R}^{2}} .$$

Similarly, for the radial direction, we find a closed-form expression in terms of the modified Bessel function of the first kind and of order zero. The radial small oscillation frequency and the Kerr nonlinearity may then be computed to be:

$${ω}_{ρ}^{2} = {ω}_{z}^{2} \frac{2 {Z}_{R}^{2}}{{w}_{0}^{2}} , {K}_{ρ} = {K}_{z} \frac{{Z}_{R}^{2}}{2 {w}_{0}^{2}}$$

Finally, note that the ponderomotive potential over the closed-shell core of alkali metals is negligible since it is several thousand times heavier than an electron (V∝1/mass).

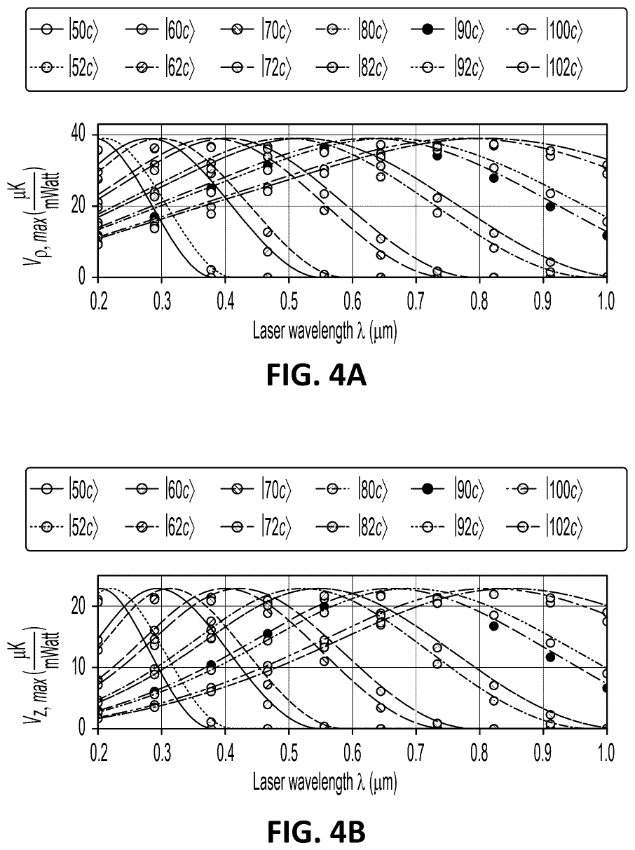

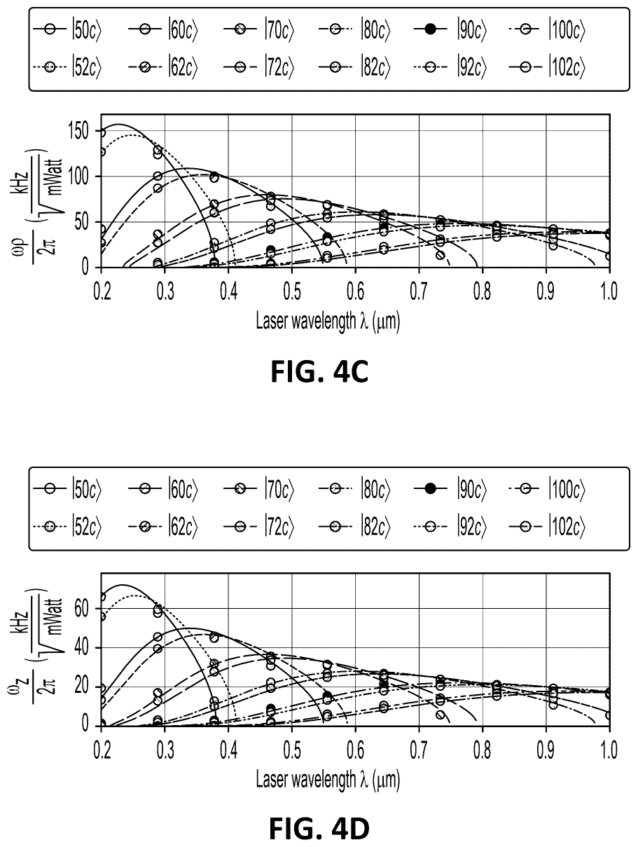

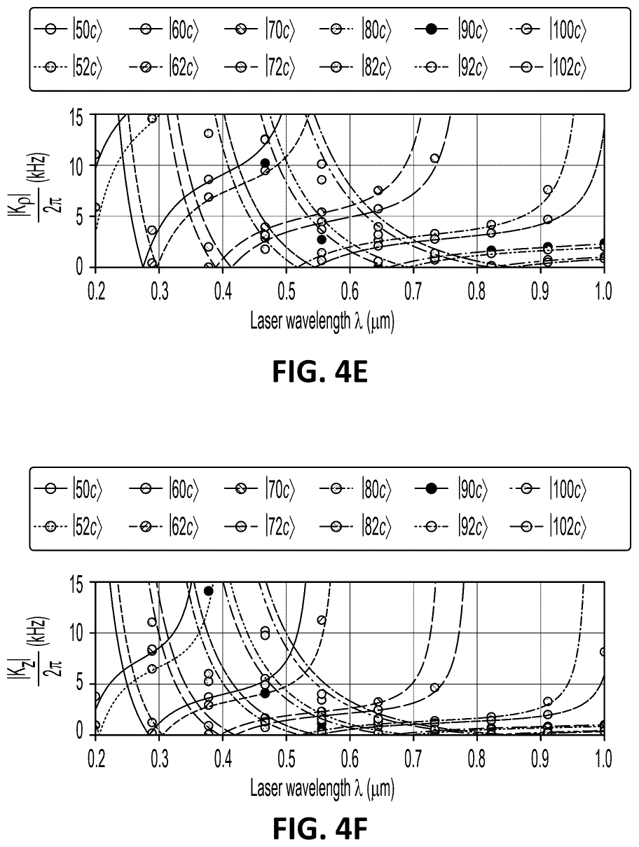

FIGS. 4A-4F show calculated radial and axial laser trapping potentials, radial and axial trap frequencies, and radial and axial Kerr frequencies as a function of trapping wavelength, λ₁, in accordance with some embodiments of the technology described herein. Each of FIGS. 4A-4F includes calculations for various circular Rydberg states (n=50, 52, 60, 62, 70, 72, 80, 82, 90, 92, 100, and 102) of an ⁸⁷Rb atom. The solid lines correspond to a semiclassical Bohr orbit approximation, and the data points correspond to numerical integration of the laser intensity over the toroidal wave function, |ψ_{nc}|².

To produce FIGS. 4A-4F, the laser beam has been constrained to a diffraction-limited Gaussian waist of

$${w}_{0} = \frac{{λ}_{1}}{π NA} = \frac{{λ}_{1}}{2} ,$$

using a numerical aperture NA≈0.65. Requiring an attractive potential by

$${\partial }_{ρ}^{2} V {\vert}_{ρ , Z = 0} > 0 ,$$

the trapping condition simplifies to

$${ω}_{z}^{2} ∝ ( 2 {r}_{nc}^{2} - {w}_{0}^{2} ) > 0$$

and thus reads

$$2 {r}_{nc} > {λ}_{1} / \sqrt{2}$$

and it can be interpreted to mean that the Bohr atom needs to be large enough to fit a photon of size≈λ₁/\sqrt{2} within its orbit. Table I provides trapping conditions for a few Rydberg states.

Note that one can relax this focusing condition by a non-diffraction-limited beam at a shorter wavelength. To give an example, the condition used here for a diffraction-limited laser at λ₁=800 nm can be achieved by a laser at λ₁=300 nm with a lens of NA<0.3.

FIGS. 4A and 4B plot the radial and axial trap depth. The thread trap provides a high trap depth. Comparable ponderomotive traps for Rydberg atoms are more than five, and up to 20, times less efficient. Their trap depth is limited by light “holes” providing typically barriers of <4 μK/mWatt. Power inefficiency is a bottleneck for proposals addressing tens of thousands or even millions of atoms in a Rydberg quantum computer.

FIGS. 4C and 4D show that essentially any pair of these circular Rydberg levels presents a focusing diameter λ₁ at which the trapping frequencies are equal. This condition, for consecutive states n and n±1 (or n and n±2), happens near the maximal trap depth. The condition along the radial direction coincides with the condition along the axial direction. This is a notable occurrence in the thread trap since it is a property of the convolution of the Gaussian beam with the circular orbit. Its origin is unrelated to the conditions of equal polarizability found at particular wavelengths in ground-state dipole traps.

FIGS. 4E and 4F plot Kerr nonlinearities, as measured by the radial (K_{ρ}) and longitudinal (K_{z}) Kerr frequencies of the trap and are shown to cross for different circular states. The vertical plotting range of the Kerr frequencies is chosen to show the parameter regime where the perturbative approximation is meaningful, while keeping the laser power at the few milliWatt level (K_{ρ,z}<<ω_{ρ,z}). Another property, that can be directly read from FIGS. 4E and 4F, is that for essentially any pair of these circular Rydberg states, there exists a focusing diameter at which the nonlinearities are equal in magnitude and opposite in sign. Note that these crossings happen close to the maximum trap depth for neighboring states and that since K∝k₄/k₂ they are independent of laser power. Note the high values of the Kerr nonlinearity. This nonlinear parameter regime, provided sufficiently low dissipation conditions, allows for the observation of purely quantum dynamics and, in particular, the generation of Schrödinger Kerr cats of a massive oscillator.

The last property to note is that the Kerr nonlinearity for any given state changes sign, passing through zero, almost simultaneously for the two trap axes (K_{ρ}≈K_{z}=0). This differs from standard optical tweezer Gaussian traps or lattices, which are constrained to have negative softening Kerr nonlinearity. This also happens near the maximum of trap depth.

In particular, the interplay of a Kerr nonlinearity and parametric squeezing in a massive quantum oscillator provides new opportunities for cold atoms. Squeezing can be generated by exploiting the property that modulating the power of the trapping laser modulates the trap frequency at constant Kerr coefficient. This nonlinear mechanical parametric oscillator could generate unprecedented control of quantum tunneling, interference in the classically forbidden region, and bosonic encoding of quantum information in the mechanical degree of freedom of a neutral atom. Much like with interacting ions, the Rydberg interaction provides the opportunity to perform logical gates between two or more oscillators. As such, this trap may bring the mechanical motion of cold circular Rydberg rubidium atoms into a regime where only highly nonlinear, low-dissipation, superconducting quantum circuits operate.

In some embodiments, the trapped Rydberg atom may be used as a computing platform, with quantum states being encoded into the trapped Rydberg atom. In particular, the regime of high nonlinearity of the thread trap may be used to observe the first generation of mechanics in the quantum optical regime. For this, a hierarchy is needed between nonlinearity and dissipation. Concretely, the main constraint is that the Kerr nonlinearity be larger than the dissipation rate.

Consider the evolution of an oscillator under ordinary dissipation, which can be described by the Lindblad equation:

$${\partial }_{t} \hat{ρ} = \frac{1}{i ℏ} [ \hat{H} , \hat{ρ} ] + κ ( \hat{a} \hat{ρ} {\hat{a}}^{†} - \frac{1}{2} ( {\hat{a}}^{†} \hat{a} \hat{ρ} + \hat{ρ} {\hat{a}}^{†} \hat{a} ) ) ,$$

where \hat{ρ} is the density operator describing the oscillator's state, Ĥ is the oscillator Hamiltonian operator, and

$$\hat{a} = \frac{1}{\sqrt{2}} ( \hat{x} + i \hat{p} ) ,$$

with [\hat{x}, \hat{p}]=i, is the bosonic annihilation operator. The first term, involving the commutator, is the Schrödinger equation of motion, while the second term (∝κ, the single photon loss rate) accounts for the nonunitary dynamics.

Importantly, the canonically conjugated position \hat{X} and momentum \hat{P} coordinates ([\hat{X}, \hat{P}]=iℏ) have already been adimensionalized. The formulation in terms of the bosonic operator â includes the introduction of a spatial metric and a momentum metric to reduce the dimensionful coordinates. It may be assumed that the system is weakly nonlinear, characterized by its small oscillation frequency, ωₒ, and its mass, m. The dimensionless coordinates read then \hat{x}=\hat{X}/\sqrt{2}X_{zps}, and \hat{p}=\hat{P}/\sqrt{2}P_{zps} where X_{zps}=\sqrt{ℏ/2mωₒ} and P_{zps}={square root over (ℏmωₒ)/2)} are the zero point spread of each coordinate. By introducing these metrics, the photon has been defined; a displacement in phase space by either 2X_{zps} or 2P_{zps} corresponds to a displacement by “one photon,” for example.

Consider an ordinary pendulum or, for that matter, any oscillator with a quartic nonlinearity. Using first-order perturbation theory to describe the regime of small oscillations, its Hamiltonian is written as:

$$\hat{H} = {ℏω}_{o} {\hat{a}}^{†} \hat{a} + {{k}_{4} ( \frac{ℏ}{m {ω}_{o}} )}^{2} {\hat{x}}^{4} + ⋯ \approx ℏ ( {ω}_{a} {\hat{a}}^{†} \hat{a} + K {\hat{a}}^{† 2} {\hat{a}}^{2} ) .$$

This is the so-called Kerr Hamiltonian in quantum optics. Its effective nonlinearity is usually quoted as the Kerr coefficient

$$K = \frac{6 {k}_{4} ℏ}{{m}^{2} {ω}_{o}^{2}} ,$$

and ωₐ=ωₒ−2K is the “Lamb-shifted” oscillator frequency. The Kerr oscillator, also known as the Duffing oscillator in nanomechanics, exhibits remarkable dynamics that have not been observed, to the best of our knowledge, for a mechanical oscillator to date.

The regime K/2π|α|²>>κ is desired to access what is known as the quantum optical regime, where the nonlinear quantum correction to the Hamilton equation of motion becomes relevant. Here |α|² is the mean number of photons in the oscillator. To date, the remarkable dynamics in this regime, and in particular the dynamical generation of Schrödinger Kerr-cat states, has only been observed in electrical analogs of mechanical systems.

To leverage the extreme mechanical nonlinearity that permits the generation of mechanical Kerr-cats, the subatomic structure of a giant circular Rydberg atom in a thread trap can be exploited. The large nonlinearity is sourced by the circular orbital whose radius is much larger than the zero-point spread of the atom (a₀n²>>X_{zps}) and thus probes the laser intensity at large and well-defined distances from the center, even for small initial displacements of the atom by a few X_{zps} from the equilibrium position. Also, being a nonresonant ponderomotive laser trapping technique, little to no heating is expected from dipolar scattering, thereby increasing the available quality factor Q=ωₐ/2πκ. Laser instabilities may then be the limiting factor for the quality factor of the oscillator.

The dynamics of a circular Rubidium atom in a thread trap is expected to develop quantum correction to classical motion along the axial and radial trapping directions. Along the radial direction, for example, the effective nonlinearity for n=80, with an orbital diameter of 640 nm, is K_{ρ}/2π≈7 kHz, independent of laser power when trapped with a Gaussian beam, which can also be used as the Rydberg excitation beam, at λ₁=420 nm focused to a diffraction-limited spot of diameter w₀=λ₁/2. The corresponding trapping frequency is ωρ/2π≈40 kHz/\sqrt{mWatt}. Assuming κ−1~30 ms (from Q≈103, as an estimate taking into account laser power fluctuations in the trap) and an initial displacement from vacuum of w₀/2 (corresponding to a coherent state am-plitude of |α|≈2 for 1 mW), it is estimated that K/2πκ≈200, which would be more favorable than the conditions encountered in and comparable with the parameter regime achievable with Josephson circuits. Note, however, that the great tunability provided by the freedom in laser wavelength, laser power, beam waist, and principal quantum number n provides many interesting configurations. In FIGS. 3B and 3C, this tunability is illustrated by the plotted trapping potential for n=60, for which a trapping frequency of ω_{ρ}/2π≈80 kHz/\sqrt{mWatt} is achieved at the expense of a shallower trap. For n=100, a vanishing linear confinement is shown.

To compare with the well-established technology of ordinary atomic dipole traps, it is noted that they typically operate in a regime where the trapping frequency is a few kHz/\sqrt{mWatt} and where linear confinement of the Gaussian-shaped potential is always strictly present. A direct comparison can be made between ordinary Gaussian tweezers and the thread trap by using he analytical expressions for the frequency

$${ω}_{ρ} = \sqrt{\frac{4 {V}_{0}}{{mw}_{0}^{2}}}$$

and the nonlinearity

$${k}_{4 , ρ} = - \frac{2 {V}_{0}}{{w}_{0}^{4}} < 0$$

of a (radial) Gaussian potential

$$V ( ρ , Z ) = - {{V}_{0} ( \frac{{w}_{0}}{w ( Z )} )}^{2} exp ( \frac{- 2 {ρ}^{2}}{{w ( Z )}^{2}} ) .$$

The thread trap provides more flexibility and larger dynamic range, sourced mainly by the freedom in wavelength it provides.

In the limit of state-dependent trapping, one may use the conditional entanglement between the circular electronic state and the motional atomic state for detection: the defocusing and refocusing of the phase space distribution will be directly reflected by the death and revival of the coherence of a superposition between two electronic states. These electronic Rydberg states can be detected by high-efficiency ionization spectroscopy. This is, the technique conventionally used to generate condition cats in linear cavities may be adapted to detect the deterministic nonlinear quantum mechanics by the revival of the “spin” coherence now in a nonlinear mesoscopic mechanical “field.”

To be more specific, one example is to prepare a quantum superposition ∝|nc [symbol] +|mc [symbol] . In this condition, the qubit coherence signal shows a characteristic and detectable beating pattern. The signal has a distinct Fourier composition corresponding to the Fock states spanning the initial state:

$$\vert α 〉 = {e}^{- \frac{\vert α {\vert}^{2}}{2}} {\sum }_{N = 0}^{∞} \frac{{α}^{N}}{\sqrt{N !}} \vert N 〉 .$$

According to the diagonalization of the conditional Kerr Hamiltonian,

$$\hat{H} / ℏ = ( {\overline{K}}_{ρ} + Δ {K}_{ρ} {\hat{σ}}_{z} / 2 ) {\hat{a}}^{† 2} {\hat{a}}^{2}$$

where \hat{σ}_{z}=|nc [symbol] nc|−|mc [symbol] mc|, these frequency components will be distributed quadratically as ΔK_{ρ}N(N−1), and they constitute evidence of the generation of Kerr-cat states.

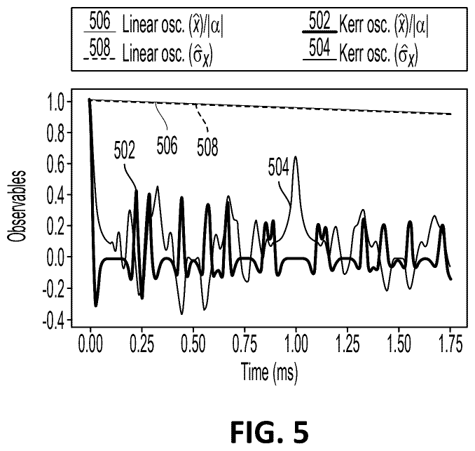

The directly detectable signal is in time-domain. FIG. 5 shows, as curves 502 and 504, the \hat{x} quadrature of the Kerr oscillator and the coherence signal of the two-level circular Rydberg electronic state \hat{σ}ₓ=|nc [symbol] mc|−|mc [symbol] nc|. The peaks in curve 502 correspond to the formation of Kerr-cat states, and the peaks in curve 504 provide information of the nonlinear quantum dynamics of the oscillator. FIG. 5 was generated by a Lindbladian simulation including oscillator damping and atomic relaxation, with n=80 and m=82. The experimental measurement corresponding to curve 504 is only sensitive to ΔK_{ρ}. Note that, in a Gaussian trap for ground state atoms, the Kerr interaction is weak and largely state-independent, and this detection mechanism cannot be used. An alternative for detection could be to use state selective decircularization and full reconstruction of the Wigner distribution by optical means.

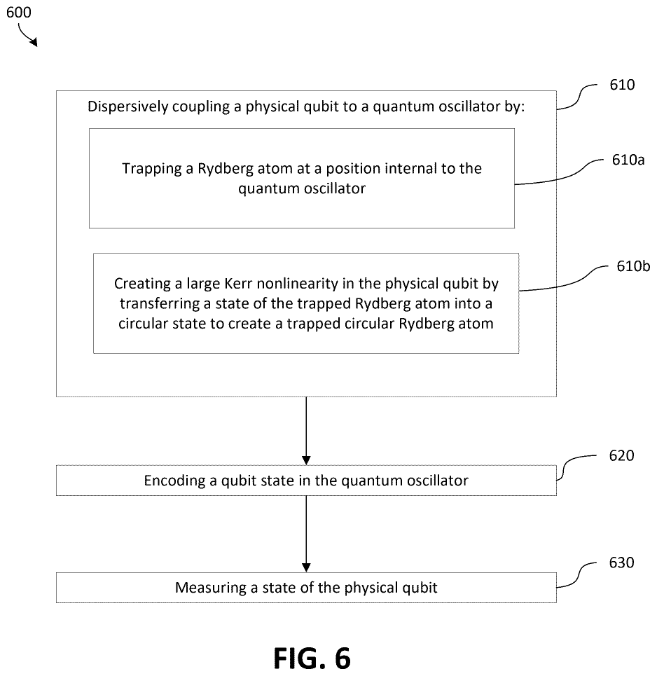

FIG. 6 is a flowchart describing a process 600 of performing quantum information processing, in accordance with some embodiments of the technology described herein. Process 600 may begin at act 610, in which a physical qubit is dispersively coupled to a quantum oscillator. Act 610 may include two sub-acts, and may begin at sub-act 610a, in which a Rydberg atom may be trapped at a position internal to the quantum oscillator.

In some embodiments, trapping the Rydberg atom may include focusing, at a focal point, a first laser beam having a wavelength, λ₁, to a Gaussian waist with a width of approximately λ₁/2. The Rydberg atom may then be positioned at the focal point such that the Gaussian waist of the first laser beam passes through the circumference of the orbital of the outermost electron of the Rydberg atom. In this manner, the Rydberg atom may be trapped at a center of the Gaussian waist of the first laser beam. Thereafter, the Rydberg atom may be excited from a ground state to an excited state using a two-photon excitation process caused by the first laser beam and a second laser beam having a wavelength, λ₂≠λ₁.

After sub-act 610a, act 610 may proceed to sub-act 610b, in which a large Kerr nonlinearity in the physical qubit may be created by circularizing the trapped Rydberg atom. The trapped Rydberg atom may be circularized by adiabatically transferring a state of the trapped Rydberg atom into a circular state (e.g., as described in connection with FIGS. 2A and 2B herein). In some embodiments, transferring the state of the trapped Rydberg atom into a circular state comprises applying circularly polarized microwave signals and/or radio frequency signals to the trapped Rydberg atom.

After act 610, process 600 may proceed to act 620, in which a qubit state may be encoded into the quantum oscillator (e.g., to initialize a state in the quantum oscillator). In some embodiments, encoding a qubit state in the quantum oscillator comprises applying one or more microwave fields to the quantum oscillator. Alternatively or additionally, a qubit state may be encoded into the quantum oscillator by creating an interaction between the quantum oscillator and the physical qubit (e.g., by creating parametric squeezing by modulating the trapping laser beam intensity at, for example, twice the modulation frequency of the trapped Rydberg atom).

After act 620, process 600 may proceed to act 630, in which a state of the physical qubit may be measured. In some embodiments, measuring a state of the physical qubit comprises measuring the state of the physical qubit using ionization spectroscopy (e.g., as described in connection with FIGS. 2B and 2C herein).

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not 10 limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

What is claimed is:

1. A quantum device, comprising:
a quantum oscillator; and
a physical qubit dispersively coupled to the quantum oscillator, the physical qubit comprising a trapped Rydberg atom.

2. The quantum device of claim 1, wherein the quantum oscillator comprises a bosonic system.

3. The quantum device of claim 2, wherein the quantum oscillator comprises a microwave resonator cavity.

4. The quantum device of claim 1, further comprising a laser trap configured to trap the trapped Rydberg atom.

5. The quantum device of claim 4, wherein the laser trap comprises:
one or more electrodes positioned adjacent a first laser beam present during operation of the laser trap; and
a lens configured to, during operation of the laser trap, focus the first laser beam to a Gaussian waist with a width less than a diameter of the trapped circular Rydberg atom.

6. The quantum device of claim 5, wherein the first laser beam has a wavelength λ₁ and the lens is configured to, during operation of the laser trap, focus the first laser beam to a Gaussian waist with a width approximately equal to λ₁/2.

7. The quantum device of claim 5, wherein the lens has a numerical aperture in a range from 0.3 to 0.9.

8. The quantum device of claim 1, wherein the trapped Rydberg atom comprises an alkali metal atom.

9. A quantum information processing system, comprising:
the quantum device of claim 1; and
one or more energy sources coupled to the quantum oscillator and the physical qubit.

10. The quantum information processing system of claim 9, further comprising a laser trap configured to trap the trapped Rydberg atom.

11. The quantum information processing system of claim 10, wherein the laser trap comprises:
one or more electrodes positioned adjacent a first laser beam present during operation of the laser trap; and
a lens configured to, during operation of the laser trap, focus the first laser beam to a Gaussian waist with a width less than a diameter of the trapped Rydberg atom.

12. The quantum information processing system of claim 11, wherein the first laser beam has a wavelength λ₁ and the lens is configured to, during operation of the laser trap, focus the first laser beam to a Gaussian waist with a width approximately equal to λ₁/2.

13. The quantum information processing system of claim 11, wherein the lens has a numerical aperture in a range from 0.3 to 0.9.

14. The quantum information processing system of claim 9, wherein the quantum oscillator comprises a bosonic system.

15. The quantum information processing system of claim 14, wherein the quantum oscillator comprises a microwave resonator cavity.

16. A method of performing quantum information processing comprising:
dispersively coupling a physical qubit to a quantum oscillator by:
trapping a Rydberg atom at a position internal to the quantum oscillator; and
creating a large Kerr nonlinearity in the physical qubit by transferring a state of the trapped Rydberg atom into a circular state to create a trapped circular Rydberg atom;
encoding a qubit state in the quantum oscillator; and
measuring a state of the physical qubit.

17. The method of claim 16, wherein encoding a qubit state in the quantum oscillator comprises applying one or more microwave fields to the quantum oscillator.

18. The method of claim 16, wherein measuring a state of the physical qubit comprises measuring the state of the physical qubit using ionization spectroscopy.

19. The method of claim 16, wherein trapping the Rydberg atom comprises:
focusing, at a focal point, a first laser beam having a wavelength, λ₁, to a Gaussian waist with a width of approximately λ₁/2;
positioning a Rydberg atom at the focal point; and
exciting the Rydberg atom from a ground state to an excited state using a two-photon excitation process caused by the first laser beam and a second laser beam having a wavelength, λ₂≠λ₁.

20. The method of claim 16, wherein transferring the state of the trapped Rydberg atom into a circular state comprises applying circularly polarized microwave signals to the trapped Rydberg atom.
